(19) United States
(12) Patent Application Publication
(10) Pub. No.: US 2003/0182223 A1
(43) Pub. Date: Sep. 25, 2003

(54) Method and program for electronic commerce

(75) Inventor: Ken Kuroda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/259,511

(22) Filed: Sep. 30, 2002

(30) Foreign Application Priority Data
Mar. 25, 2002 (JP) 2002-082689

(51) Int. Cl. G06F 17/60

(52) U.S. Cl. 705/37

(57) ABSTRACT

Electronic commerce is performed by building a commercial product trading market on a server, and connecting a buyer side device and a seller side device via a network. In the electronic commerce, idle products held by a seller are registered in the ordinary trading market by specifying at least a desired sales price, reject or not when transaction is not agreed upon, and a desired reject price when rejecting the products. In the ordinary trading market, if there is a bid satisfying the desired sales price, a contract processing for trading the idle products is executed. When there is no bid satisfying the desired sales price, or when there is no bid at all, the idle products are registered in the reject market on the basis of the specification of rejection made when transaction is not agreed upon. In the reject market, when there is a bid satisfying the desired reject price, a contract processing of rejection of the idle products is executed.

### BACKGROUND OF THE INVENTION

1. Field of the Invention

The present invention relates to a method and a program for electronic commerce performing commercial transactions by use of internet. More particularly, the invention relates to a method and a program for electronic commerce conducting reuse and rejection of idle products such as idle information devices used within an enterprise through electronic market trading.

2. Description of the Related Arts

There is at present an increasing tendency toward investment in information equipment in business enterprises. In addition, technical innovation in information devices is very rapid, resulting in a service life of products of only a few years in many cases. An enterprise has departments absolutely requiring the most modern equipment and devices, and has on the other hand departments not demanding for a high performance of equipment. It is therefore a common practice to carry out inhouse management of idle products and reuse such products in other departments. Some companies purchase products secondhand at low costs and sell the same. General consumers use this system to buy information devices at low costs.

Within a business enterprise, however, performance requirements for information devices do not differ much between departments, so that obsolete information devices becoming unnecessary in a department can rarely be effectively used in the other departments within a company. Furthermore, because of such problems as the tendency toward lower prices of information devices and difficulty in acquiring maker's support for used products, effective use of idle products is not so actively promoted. Idle products for which a reusing location has not been found would be rejected, but the rejecting cost is very high for information devices because of the difficulty of rejection and is becoming a social issue. Environmental problems are sometimes caused by an improper disposal. A secondhand product seller serves as a broker who purchases used information devices from sales applicants and sells such devices to purchase applicants. Since the value of information devices subject to rapid technical innovations tends to decrease rapidly with time, the brokerage is exposed to a very high risk. It is therefore necessary to hold down the purchase price, thus reducing merits for the sales applicant. On the other hand, it is difficult even for an enterprise having no particular need for using the most modern equipment to procure used products satisfying the need. Such an enterprise often purchases new products, and is therefore forced to make an equipment investment in information devices over the necessity. For conventional idle information devices, as described above, appropriation of devices is not conducted effectively, and the rejection cost is rather high. The problem is that enterprises make an investment in informational equipment not meeting the actual business needs.

### SUMMARY OF THE INVENTION

According to the present invention, there are provided a method and a program for electronic commerce which forms a market for distribution of idle products within enterprises, and builds novel market transactions, being conscious of management of the market, effective reuse of information devices, and even rejection of information device.

The present invention provides a method for electronic commerce which permits construction of a trading market of goods in a computer, and execution of business by connecting a buyer's computer and a seller's computer via a network. This method for electronic commerce comprises:

a registering step of causing a seller to register an idle product held by the seller on the market by specifying at least a desired sales price and a desired reject price in the case of rejection;

a purchase bidding step of soliciting the seller to make a bid by specifying a desired purchase price for an idle product rejected on the business market;

a market trading step of registering the idle product on the reject market when there is no bid satisfying the desired sales price upon the lapse of a prescribed business period;

a reject bidding step of causing reject disposers to make a bid by specifying a rejecting cost for an idle product registered on the reject market; and

a reject market trading step of checking presence or absence of bids upon the lapse of a prescribed business period, and executing a contracted disposal of the idle product when there is a bid satisfying the desired reject price.

According to the method for electronic commerce of the invention, therefore, it is possible for a business enterprise to effectively reuse information devices and the like held by the enterprise as idle products. For an enterprise desiring to purchase, it is possible to reduce the information equipment investment, and since rejection is a prerequisite, a very low contract price can be expected. An enterprise having idle products can contract with a reject disposer proposing the lowest price even in case of rejection.

In this method for electronic commerce, the registering step comprises, when the idle product is an information device, a sub-step of providing the seller with a prescribed test program, and registering and disclosing the test result on the idle product obtained by the execution of the test program; and a sub-step of providing the buyer with the test program, thereby enabling the buyer to obtain information about performance of the idle product of which the test result is registered through execution of the test program on an information device held by the buyer. As a result, the performance of an information device registered in the market is objectively grasped and assured, and it is possible to efficiently obtain information devices meeting a performance requirement of the buyer at low costs.

The registering step causes specification of a first minimum trading price and a last minimum trading price. In this case, an amount obtained by dividing the difference between the first minimum trading price and the last minimum trading price by the number of runs of auction is used as an amount of reduction per auction. As a result, a sliding sales price stepwise decreasing is applicable to an idle product registered in the market in response to seller's desire through a plurality of runs of auction, resulting in dynamic market trade meeting the quality and needs of the idle products, and hence activating market transactions.

The reject bidding step permits purchase bidding specifying a negative purchase price for an idle product registered in the reject market. The reject market originally anticipates bidding by reject disposing enterprises. In the present invention, however, the reject market anticipates bidding for reuse of goods put on the reject market apart from the above to cause information devices to be received by a bidding of a negative price by the buyer, thereby permitting expectation of a remarkable curtailment of the reject cost.

The reject bidding step permits a blanket bidding in units of seller for an idle product registered in the reject market. It is not therefore necessary for a reject disposer to make a bid for each of the products, but it is possible to make a blanket bid for a lump of idle products registered in the reject market for a particular enterprise, thus improving efficiency of market transactions for rejection.

According to the method for electronic commerce of the invention, there is provided a market examination step of investigating a trouble occurring in the trading at the request of a party to a trade effectively made in the trading market or the reject market, and imposing a penalty on a violating party. As a result, a trouble occurring in the electronic commerce is rapidly and appropriately solved, and an unfair trade is excluded, thus permitting maintenance and improvement of reliability of electronic commerce.

The present invention provides a computer program building a server for electronic commerce. The program causes the computer to execute:

a registering step of causing registration of an idle product held by a seller in a trading market by specifying at least a desired sales price, and a desired reject price if the idle product is to be rejected;

a purchase bidding step soliciting a buyer to make a bid by specifying a desired purchase price for an idle product registered in the trading market;

a market trading step of registering the idle product in the reject market when there is no bid satisfying the desired sales price at a point in time upon the lapse of a prescribed business period;

a reject bidding step of causing a reject disposer to make a bid by specifying reject cost and prices for an idle product rejected in the reject market; and

a reject market trading step of checking the presence or absence of bids upon the lapse of a prescribed business period, and when there is a bid satisfying the desired reject prices, executing a contract of rejecting the idle product.

The details of the program of the invention is basically the same as the method for electronic commerce.

The above and other objects, features and advantages of the present invention will become more apparent from the following detailed description with reference to the drawings.

### BRIEF DESCRIPTION OF THE DRAWINGS

FIGS. 1A and 1B are block diagrams of the functional configuration in a network environment to which the electronic commerce of the present invention is applied;

FIGS. 2A and 2B are descriptive views of the idle product electronic commerce having an ordinary trading market and a reject market built in accordance with the invention;

FIG. 3 is a descriptive view of the participant database shown in FIGS. 2A and 2B;

FIG. 4 is a descriptive view of the idle product database shown in FIGS. 2A and 2B;

FIG. 5 is a descriptive view of the reject database shown in FIGS. 2A and 2B;

FIG. 6 is a flowchart of the participant registration processing in the invention;

FIG. 7 is a flowchart of the electronic commerce according to the invention;

FIGS. 8A and 8B are descriptive views of the market participant registering screen in the invention;

FIG. 9 is a descriptive view of the exhibitor retrieval screen for purchase bidding in the invention;

FIG. 10 is a descriptive view of the exhibitor screen retrieval in the invention;

FIG. 11 is a flowchart of the minimum price slide processing shown in FIG. 5;

FIG. 12 is a flowchart of the reject market processing shown in FIG. 5;

FIG. 13 is a descriptive view of the blanket reject disposers bidding screen used for reject bidding;

FIG. 14 is a flowchart of the contract processing shown in FIG. 5; and

FIGS. 15A and 15B are flowcharts of the complaint processing shown in FIG. 14.

### DETAILED DESCRIPTION OF THE PREFERRED EMBODIMENTS

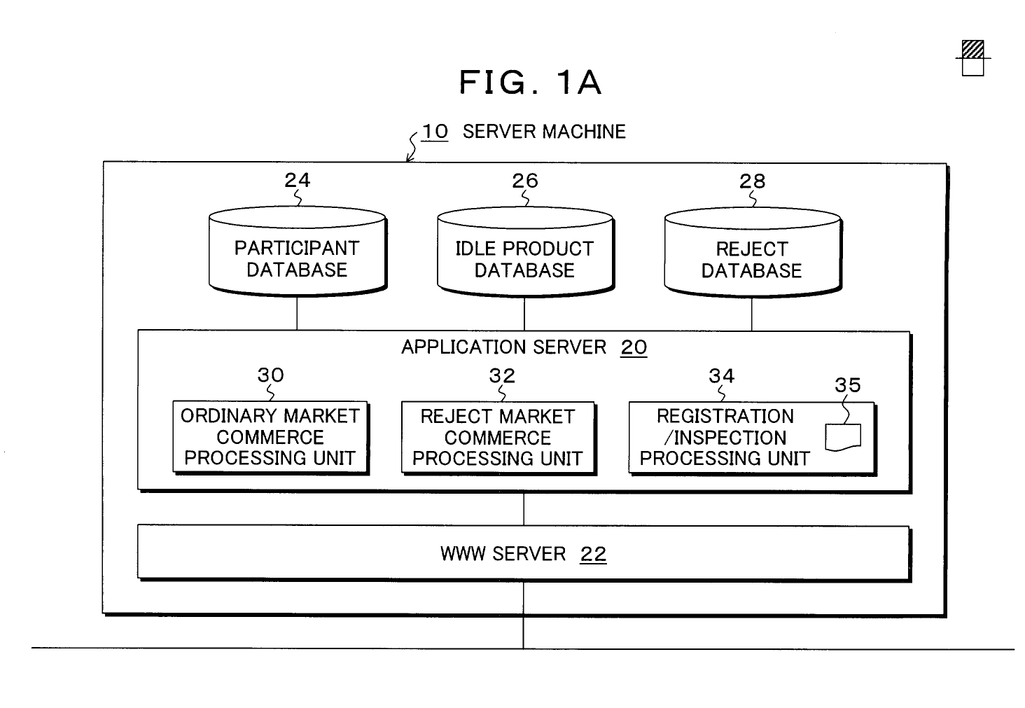

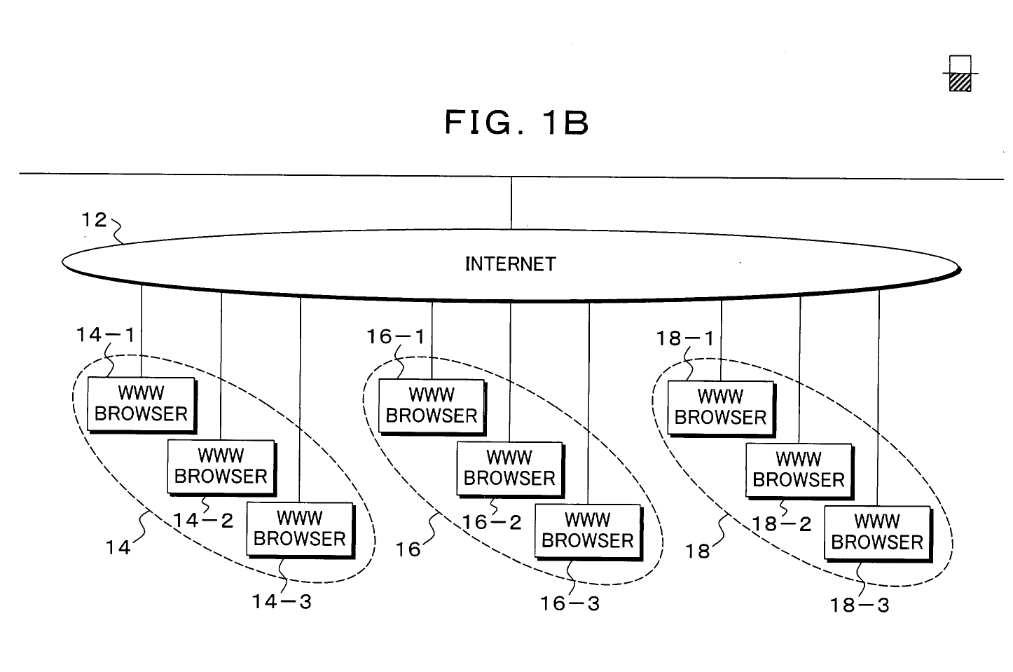

FIGS. 1A and 1B are a block diagram of the functional configuration in a network environment to which the electronic commerce of the present invention for idle products is applied. Commercial transactions of idle products in the present invention are performed in a server machine 10. Clients participating in electronic commerce are connected to the server machine 10 via internet 12. In electronic commerce of idle products of the present invention, there are sale wishing enterprise group 14 selling the idle products, a purchase wishing enterprise group 16 purchasing the idle products, and a reject disposing enterprise group 18 participating in the reject market formed when market transaction of the idle products fails, as against the server machine 10 side establishing a trade market and operating and managing the same. The sale wishing enterprise group 14 comprises sale wishing enterprise clients 14-1 to 14-3; the purchase wishing enterprise group 16 comprises purchase wishing enterprise clients 16-1 to 16-3; and the reject disposing enterprise group 18 comprises reject disposing enterprise clients 18-1 to 18-3. Each client can participate in the transaction by perusing a homepage of commerce of the server machine 10 by means of a www browser. Participants, which are enterprises in this embodiment, include individuals. The server machine 10 comprises an application server 20, a www server 22, a participant database 24, an idle product database 26, and a reject database 28. An ordinary market commerce processing unit 30, a reject market commerce processing unit 32 and a registration/inspection processing unit 34 are provided in the application server 20. The registration/inspection processing unit 34 has a test program 35 for verification on the participant side in a case where idle products are information devices such as computers. In this configuration, the application server 20 provided in the server machine 10 has at least the following steps of processing procedure to be carried out by the ordinary market commerce processing unit 30 and the reject market commerce processing unit 32:

(1) Registration Step:

Specifying at least a desired sales price, reject or not in failure of transaction, and a desired reject price in case of reject and registering idle products, held by a sale wishing enterprise group 14 serving as a seller, in a virtual trade market built by the application server 20;

(2) Buyer Bidding Step:

Receiving bids specifying desired purchase prices from the purchase wishing enterprise group 16 for the idle products registered in the trade market built by the server machine;

(3) Enterprise Commerce Processing Step:

Checking the presence of a bid upon the lapse of a prescribed period of time, and when there is a bide satisfying the desired sales price, performing the contract processing of the idle product contract. Registering the idle products in the reject market in accordance with reject specification upon failure of transaction when there is not bid satisfying the desired sales price or there is existent no bid at all. In the absence of a reject specification upon failure of transaction, erasing the registration from the ordinary trade market. Upon conducting processing of an actual ordinary market transaction, carrying out a run of auction by dividing the interval between transactions into certain units of interval between transactions, and upon failure of transaction, conducting a minimum price sliding processing of repeating an auction with a reduced price.

(4) Reject Bidding Step:

For the idle products registered automatically because of the failure of transaction in the ordinary commerce market, receiving bids specifying reject market prices from the reject disposing enterprise group 18. Bids in the reject market include purchase bids specifying negative purchase prices from the purchase wishing enterprise group 16.

(5) Reject Market Commerce Processing Step:

Checking the presence of a bid upon the lapse of a prescribed period of time, and when there is a bid satisfying the desired reject price, performing the contract processing of the idle product rejection. When there is not bid satisfying the desired reject price, or there is not bid at all, erasing the registration in the reject market.

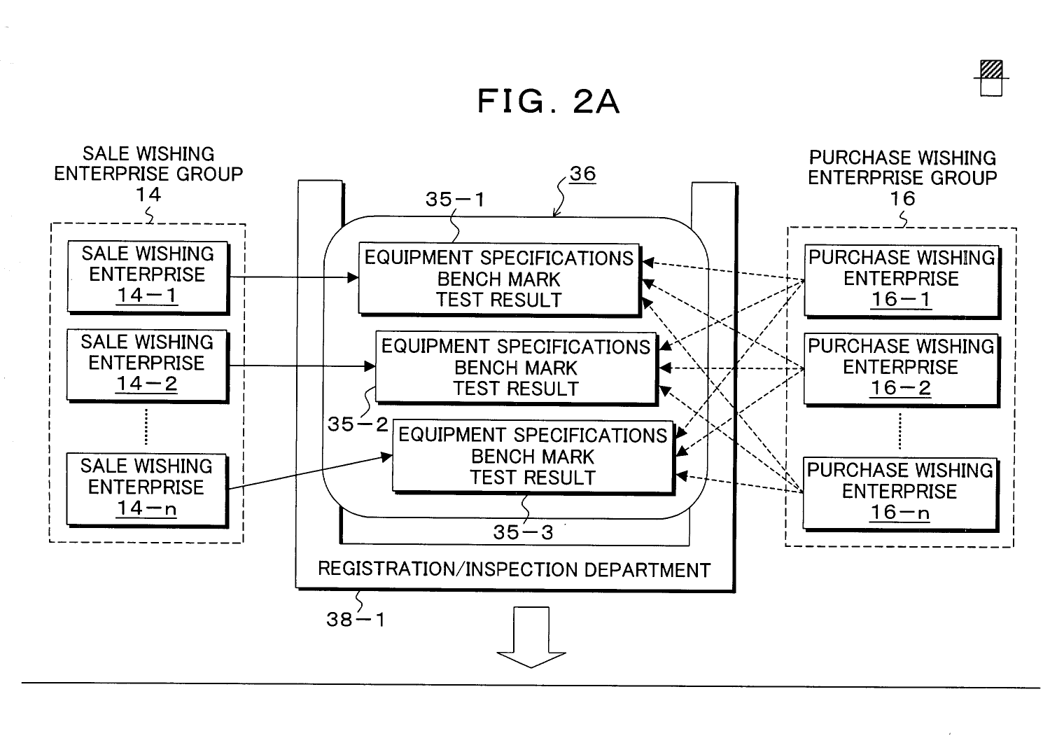

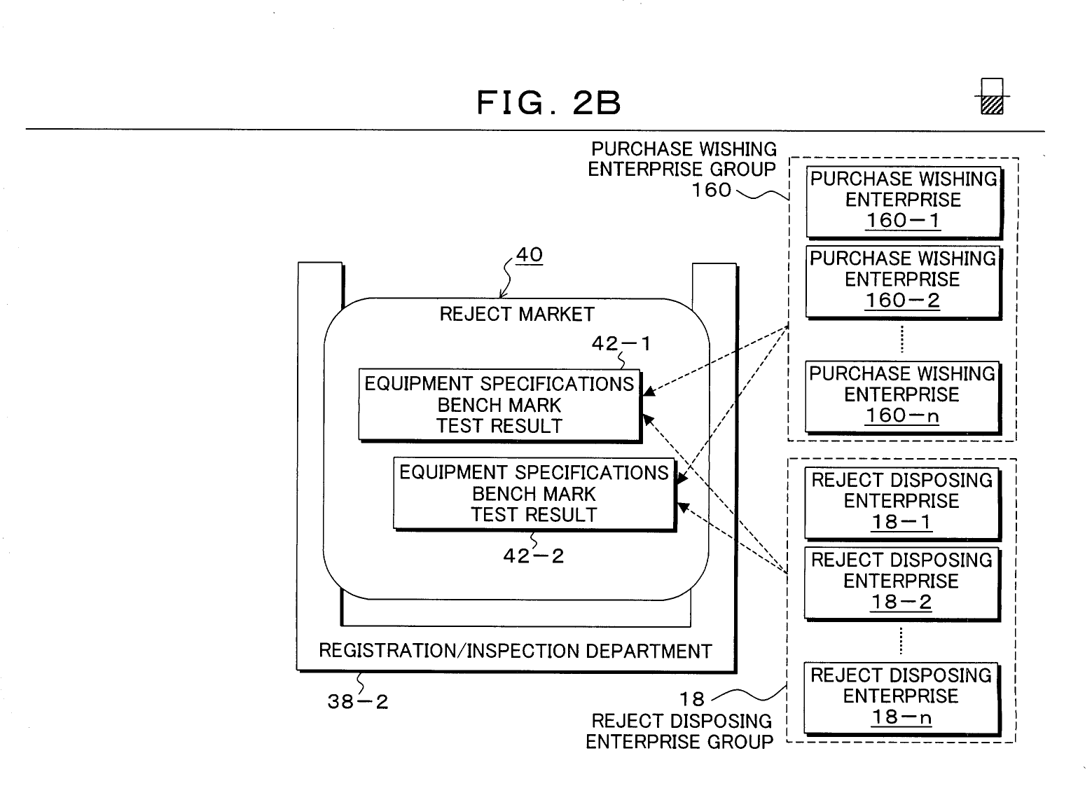

FIGS. 2A and 2B are descriptive views of the electronic commerce of idle products of the present invention having virtual ordinary commerce market and reject market built by the server machine 10 shown in FIG. 1. In the ordinary commerce market 36 virtually constructed on the server machine, the seller side comprising sale wishing enterprise clients 14-1 to 14-n belonging to the sale wishing enterprise group 14 conducts participating registration. Simultaneously with this, the buyer side comprising purchase wishing enterprise clients 16-1 to 16-n belonging to the purchase wishing enterprise group 16 conducts participating registration. This participating registration of sellers and buyers is received, registered and managed by the registration/inspection department. The seller side belonging to the sale wishing enterprise group 14 after the participating registration register idle products 35-1 to 35-3 that the seller side is going to sell in the ordinary commerce market 36. The registration of the idle product 35-1 covers the result of a bench mark test resulting from execution of the test program provided by the registration/inspection department 38-1, in addition to general pieces of information such as machine specifications including the type of product, and the service life, and the idle products 35-1 to 35-3 having these machine specifications and bench mark test result are disclosed to the buyer side belonging to the purchase wishing enterprise group 16. It is necessary for the seller side registering the idle products 35-1 to 35-3 to specify at least:

(1) Desired sales price;

(2) Transfer or not to the reject market upon failure of trade; and

(3) Desired reject price in the reject market.

For the idle products 35-1 to 35-3 registered in the ordinary commerce market 36, the seller side belonging to the purchase wishing enterprise group 16 makes a bid by specifying a desired purchase price. When a transaction is agreed upon within a prescribed business period, a contract is concluded. If a transaction is not agreed upon within the business period, the idle products are automatically transferred to the reject market 40, in accordance with a transfer instruction, to the reject market 40 of the seller side, and registered as rejects 42-1 and 42-2. In the reject market 40, the reject disposing side belonging to the reject disposing enterprise group 18 makes a bid by specifying a rejecting price. In the reject market 40, purchase wishing enterprise clients 160-1 to 160-n belonging to the purchase wishing enterprise group 160 desiring to purchase the rejects 42-1 and 42-2 are also allowed to make bids. The purchase wishing enterprise group 160 makes a bid by specifying a negative purchase price to the reject market 40, compete in bidding with the reject disposing enterprise group 18 making a bid by specifying a reject price. When a transaction is agreed upon within a prescribed business period in the reject market 40, a rejecting contract is entered into. If a transaction is not agreed upon, the registration of the rejects in the reject market 40 is erased. A registration/inspection department 38-2 is provided also in the reject market 40. The registration/inspection department 38-2 receives and manages participating registration of participants of the reject disposing enterprise group 18 participating in the reject market 40 and those of the purchase wishing enterprise group 160. When a transaction of rejects is agreed upon with the purchase wishing enterprise group 160 making a bid by specifying a negative price to the reject market 40, the registration/inspection department 38-2 executes a bench mark test of the rejects effectively used as used products using a test program at the request of the purchase wishing enterprise group 160 side, and notifies the test result. Use of the registration/inspection departments 38-1 and 38-2 arranged for the ordinary commerce market 36 and the reject market 40 is basically subject to the desire of the product purchaser side. For example, when the test result for the idle products rejected in the ordinary commerce market 36 is determined not to satisfy the performance requirements presented by the seller side, the other party may request the registration/inspection department 38-1 to conduct an inspection. At this request, the registration/inspection department 38-1 confirms operations by use of the test program. If the performance requirements presented by the seller side are not satisfied, for example, the transaction is discontinued. In this case, the seller side would pay a penalty to the registration/inspection department 38-1 and a buyer side making a successful bid. If the performance requirements are satisfied, a purchase obligation occurs on the buyer side successful in bidding. In this case, the cost incurred in inspection would be paid by the buyer side. In the bid in the reject market 40, the buyer may make a blanket bidding for rejects of a type of the seller since it is troublesome to make a bid for each of the rejects. When making a blanket bidding, the transaction becomes invalid if even only one reject is covered by others' successful bid.

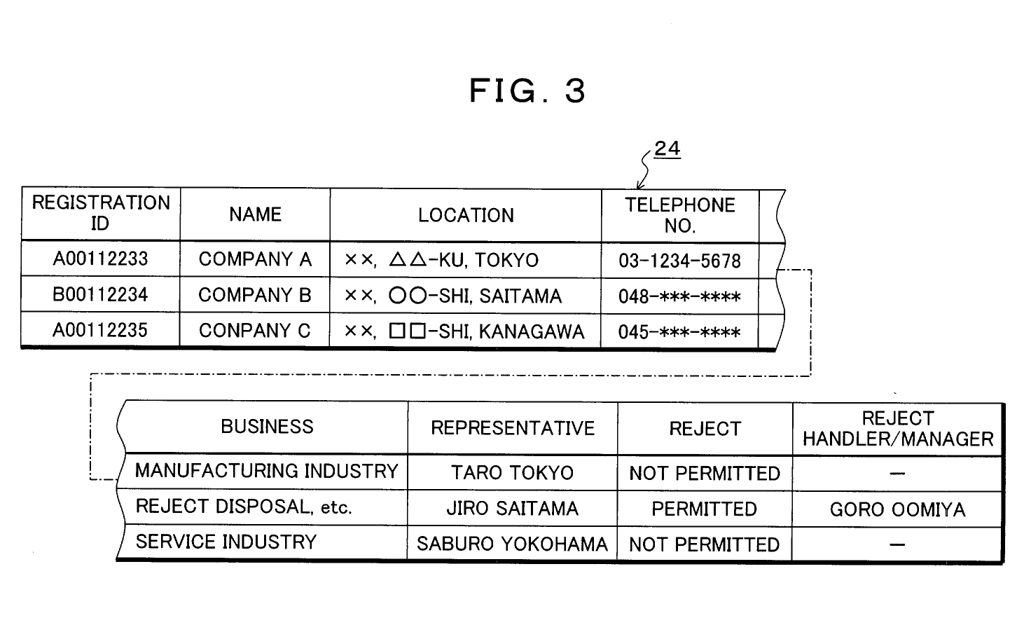

FIG. 3 illustrates the data structure of the participant database 24 provided in the server machine 10 shown in FIG. 1. Records containing pieces of information such as the registered ID, the name, the location, the telephone number, the business details, the representative, participating or not in the reject market, and the registered reject handler/manager are stored by participant in the participant database 24.

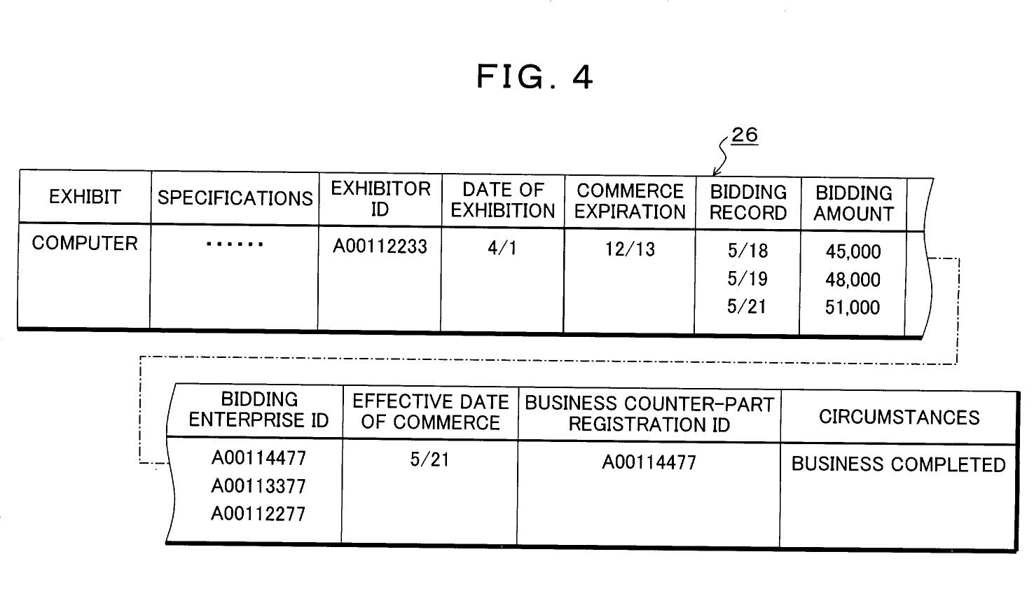

FIG. 4 illustrates the data structure of an idle product database 26 provided in the server machine 10 shown in FIG. 1. The status of commerce such as idle products registered in the ordinary commerce market is stored in the idle product database 26. More specifically, pieces of information such as the exhibited product names, the specifications, the exhibiting enterprise ID, the date of exhibition, the deadline of commerce, the bidding record, the bidding amount, the bidding enterprise ID, the date of agreement upon transaction, the registered ID of the other party, and conditions of business are stored in the idle product database 26 in the form of records in units of idle products.

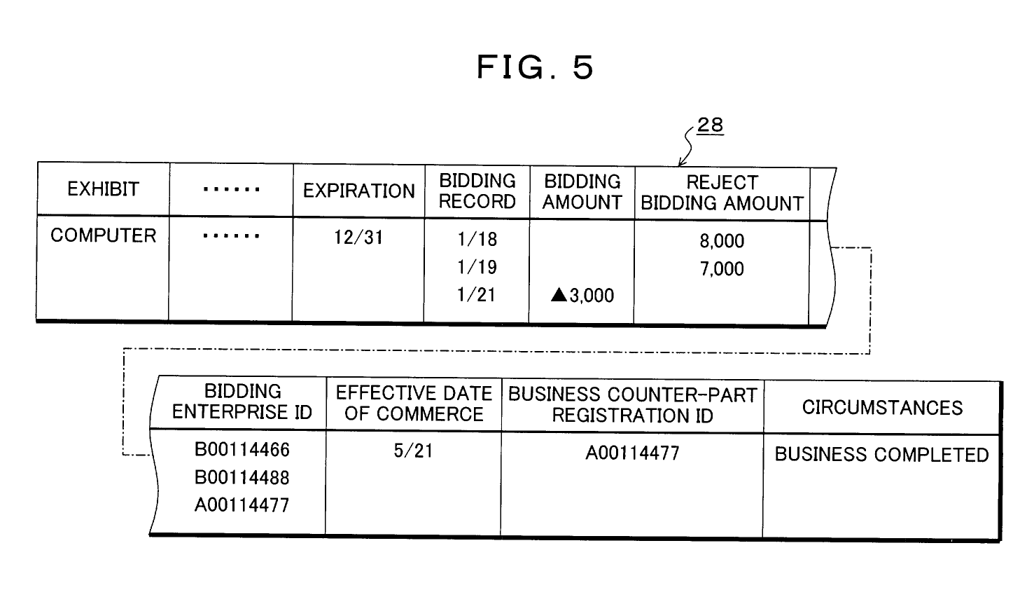

FIG. 5 illustrates the data structure of a reject database 28 provided in the server machine 10 shown in FIG. 1. The reject database 28 stores the status of transactions of the idle products registered in the reject market. More specifically, records are stored by idle product, containing, in addition to the exhibited idle products, like the idle product database 26 shown in FIG. 4, the specifications, the exhibiting enterprise ID, the date of exhibition, as well as the deadline of business, bidding record, the amount of bidding, the amount of reject bidding, the bidding enterprise ID, the date of agreement upon transaction, the registered ID of the other party enterprise, and the status of business.

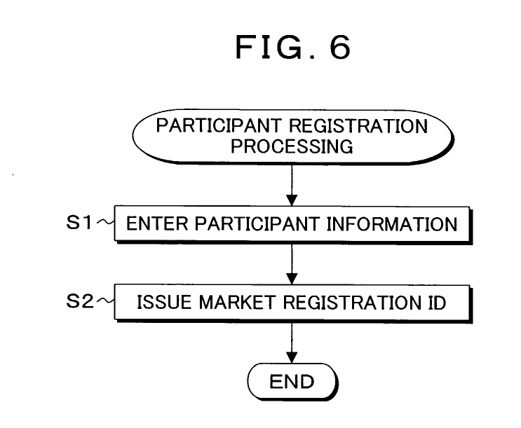

A concrete embodiment in electronic commerce of the present invention will now be described. In the electronic commerce of the invention, it is necessary to perform a participant registration processing shown in the flowchart of FIG. 6. The participant registration processing comprises entering participant information in step S1. Input items of participant information consisting of basic information such as the company name, the location, the contact and the business details of the participation applicant are entered from the screen of www browser. Upon receipt of the input of the participant information, if no defective input is found in step S2, the server side issues a registration ID to the participation applicant. When participating in the commerce, therefore, the participant should always logs in and perform authentication with the ID issued from the server side. A participant who participates as a reject disposing enterprise in the reject market must register also an industrial reject handler/manager and his or her approval number. The reject enterprise ID is discriminated from general participants' ones, permits the reject enterprise to make a bid in the reject market as a reject disposing enterprise. This participant registration processing permits, for example, construction of a participant database 24 as shown in FIG. 3.

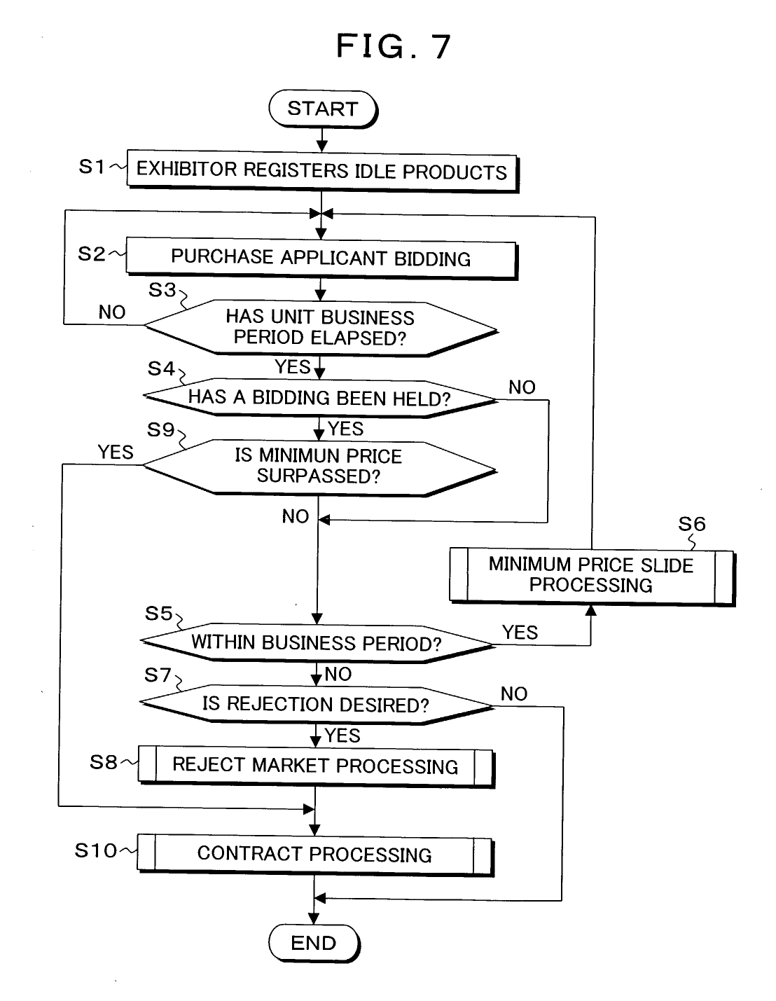

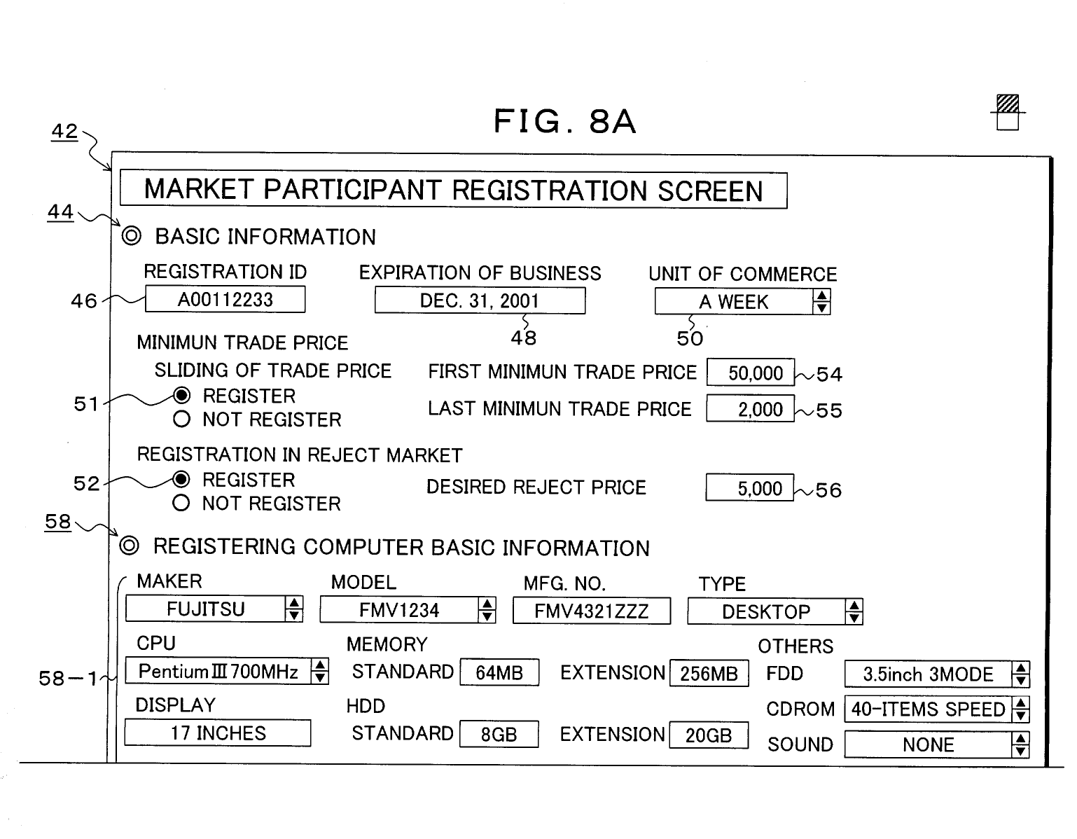

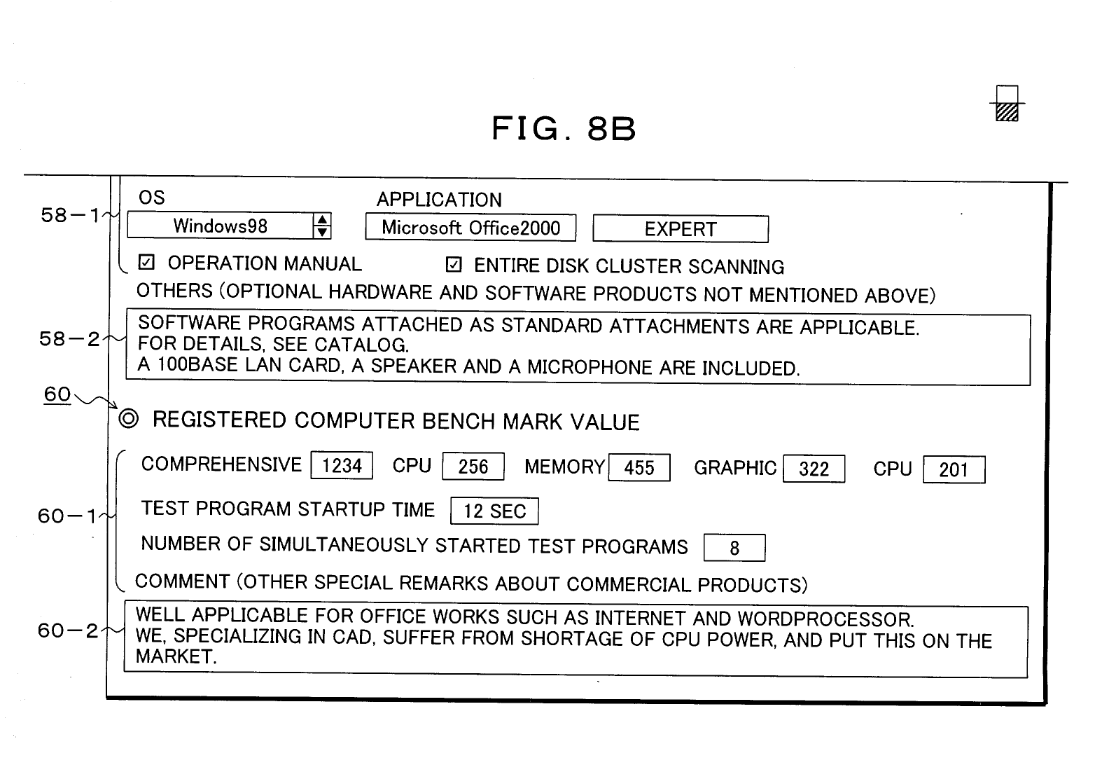

FIG. 7 is a flowchart of the processing procedure of electronic commerce as a whole of the present invention. In FIG. 7, the exhibiter registers idle products in step S1. The description hereafter covers a case where computers are handled as idle products. When registering computers as idle products, a sale wishing enterprise downloads the test programs from the web page of the server machine 10 onto the client. The test programs downloaded from the server machine 10 side contain execution modules of bench mark test for the CPU, the memory, the graphics and the hard disk, and are client programs running on a general OS. System diagnosis programs such as an MDD memory and a startup time measuring program are included in these test programs. A sale wishing enterprise executes continuously, for example, a plurality of times the test programs on information devices to be sold, and samples the test result. The sale wishing enterprise requests registration of idle products to be sold by use of the web page of the idle product commerce market. The request for registration is accomplished, for example, using a market participant registration screen 42 shown in FIGS. 8A and 8B.

Three items including the basic information 44, registration computer basic information 58 and a registration computer bench mark value 60 are provided in the market participant registration screen 42 shown in FIGS. 8A and 8B. Pieces of basic information 44 such as a registration ID, a business deadline 48, a trading unit 50, sliding check 51 of trading price, registration 52 in the reject market, the initial minimum business price 54, the last minimum business price 55 and the desired reject price 56 are entered or checked up as required. In addition to the business prices of information 58-1 such as the maker, the machine model, the manufacturing number, the type and the CPU, the seller's comment 58-2 is provided in the registration computer basic information 58-1. The registration computer bench mark value 60 includes seller's comment 60-2, apart from the bench mark value 60-1 which is the result of execution of the test programs provided by the server.

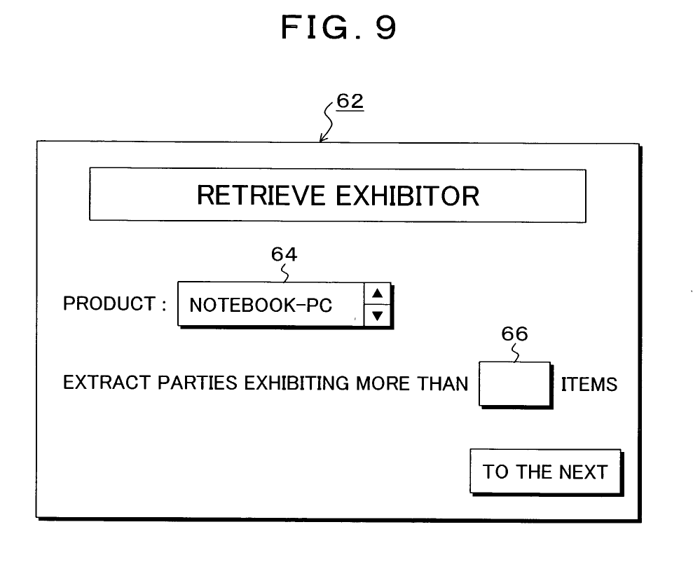

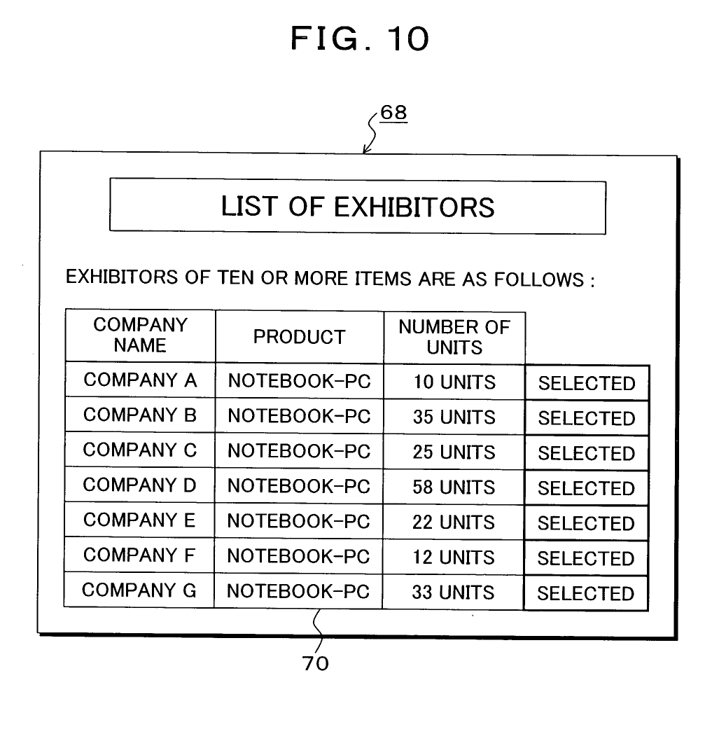

Referring again to FIG. 7, applicants for purchase make bids for purchase of the idle products registered in the ordinary trading market in the next step S2. This bidding is made, for example, by using an exhibitor retrieving screen 62 as shown in FIG. 9. The exhibitor retrieving screen 62 contains a product selecting section 64 and a quantity selecting section 66. When executing by entering necessary items, the screen 62 is changed over to a retrieval result screen 68 shown in FIG. 10. An exhibited idle product list 70 corresponding to retrieval conditions is displayed on the retrieval result screen 68. An enterprise wishing to purchase therefore selects the corresponding item from the exhibited idle product list 70 and checks details of the idle products. More specifically, details of idle product registration are laid open on a market participant registration screen 42 shown in FIGS. 8A and 8B for each item of the exhibited idle products. It is thus possible to retrieve desired products by viewing these details. The purchase wishing enterprise can gasp an outline of performance of the exhibited idle products by downloading the test program the test program from the web page of the server machine 10 to confirm performance of computers registered as idle products which the enterprise wishes to purchase, and operating the test program on an information equipment held by the enterprise. When an idle product to be purchased is thus determined, the purchase wishing enterprise specifies a desired purchase amount for the idle product to be purchased and makes a bit by entering the amount into the web page of the ordinary trading market. For the management of the ordinary trading market of the present invention, an auction is managed in units of a unit business period desired by the applicants for sale upon registration, for example, “a week” set as a unit business period 50 in the base of the market participant registration screen 42 shown in FIGS. 8A and 8B. For this purpose, when a bid is received from an applicant for purchase in step S2, it is checked whether or not a unit business period of, for example, a week has elapsed in step S3. Upon expiration of a week, the process advances to step S4, in which it is checked whether or not there has been a bid. When there has been no bid in step S4, or when, although there has been a bid, the amount of bid is lower than the minimum price in step S9, it is checked that this is within the business period in step S5, and then, the minimum price slide processing is executed in step S6. This minimum price slide processing is carried out in a case where the applicant for sale has selected the slide processing upon registration. If the applicant for sale has not selected the slide processing, a second auction of step S2 is held while maintaining the fixed minimum price.

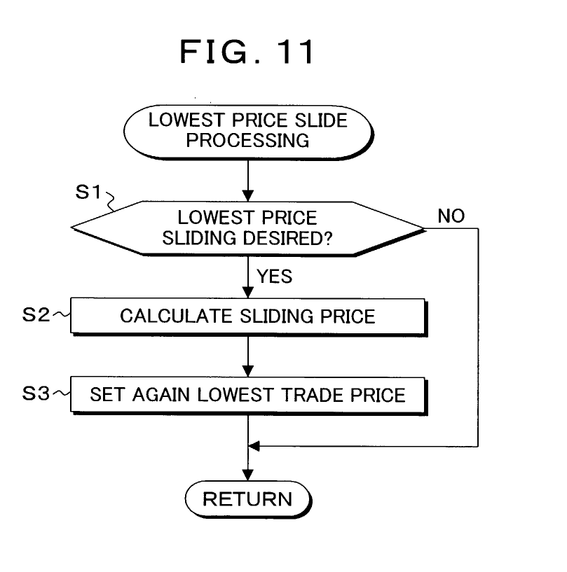

FIG. 11 is a flowchart illustrating details of the minimum slide processing in step S6 shown in FIG. 7. In step S1, it is checked whether or not the applicant for sale has desired the minimum price sliding upon registration. When it has been desired, a sliding price is calculated in step S2. The calculation of the sliding price to be reported for each auction covers an amount obtained by dividing by the number of auctions the balance of subtraction of the amount of the last minimum trading price 55 from the amount of the initial minimum trading price 54 set by the applicant for sale on the market participant registration screen 42 shown in FIG. 8. The case shown in FIGS. 8A and 8B, for example, the initial minimum trading price ¥50,000 and the last minimum trading price ¥2,000 result in a balance of ¥48,000, and there are four auctions if there are four weeks before the deadline of business, leading to a sliding price ¥12,000 for a run. After calculating the sliding price in step S2, a minimum trading price is set again in step S3. For example, if the initial minimum trading price was ¥50,000, an amount of ¥38,000 calculated by subtracting the sliding price of ¥12,000 is set in this case. If no trading price is agreed upon in any of the subsequent auctions, the minimum price is reduced stepwise from ¥26,000 to ¥14,000 and then to the last minimum trading price ¥2,000. It is needless to mention that the initial and last minimum trading prices desired by the applicant for sale shown in FIGS. 8A and 8B and the desired reject price are not disclosed to the buyer side.

Referring again to FIG. 7, if there is no bid at all in the ordinary trading market, or if, although there is a bid, the amount of bid is lower than the minimum price, when reaching the business deadline desired upon registration is determined in step S5, the process goes to step S7 to check whether or not reject has been desired upon registration. If reject has been desired, the process transfers to the reject market processing in step S8. When transfer to the reject market is not desired, the auction of course comes to an end. Transfer to the reject market processing when it is desired results in automatic transfer to the reject market on the day following the date of business deadline.

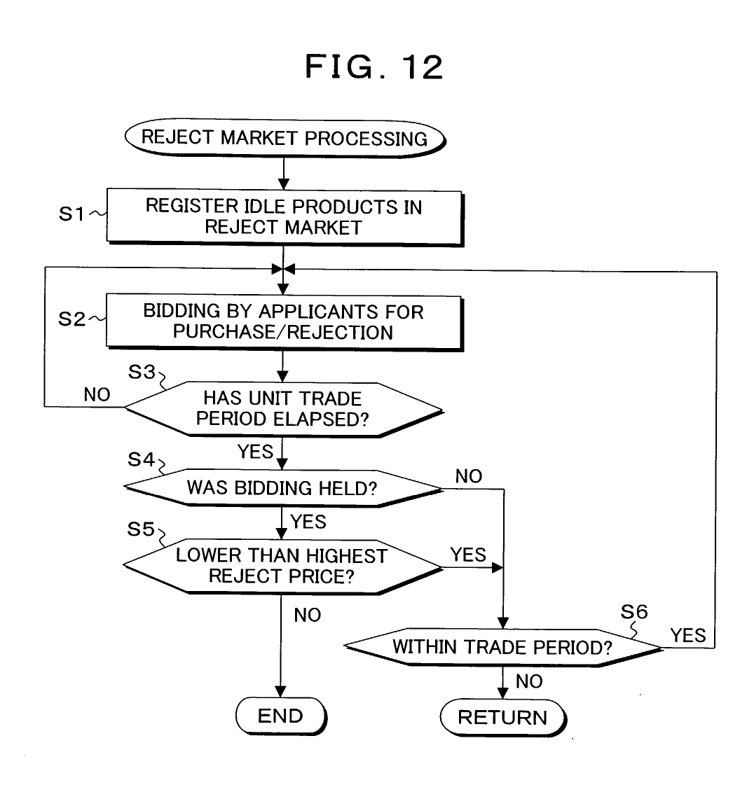

FIG. 12 is a flowchart illustrating details of the reject market processing in step S8 shown in FIG. 7. In step S1, idle products for which business is unsuccessful in the ordinary trading market are registered in the reject market. Then in step S2, applicants for purchase or applicants for reject processing make their bids. A bid of an applicant for purchase for the reject market is made at a negative price, this meaning that, when the bid is successful, the bidder receives the idle products from the sale wishing enterprise by receiving the amount expressed by the negative price of bid. An applicant for reject processing makes a bid by specifying a reject disposal cost. Then in step S3, it is checked whether or not a unit business period specified upon registration, for example, a week, has elapsed. Upon the lapse of a week, it is checked, in step S4, whether or not there has been a bid. When there has been no bid, it is checked, in step S6, whether or not it is before the business deadline. If it is before the business deadline, the second auction is started in step S2. When there is a bid in step S4, the process goes to step S5, and it is checked whether or not the amount is equal to the maximum reject price specified by the applicant for sale upon registration. If the maximum reject price is exceeded, the business is deemed to be unsuccessful, and the process comes to an end. If the amount is lower than the maximum reject price, the process advances to step S6, and if it is before the business deadline, the second auction is started in step S2. When the business period has elapsed, the process returns back to the main routine shown in FIG. 7 by deeming the case of successful transaction in the reject market, and the contract processing is carried out in step S10. In this reject market processing, a bid may be made for each item, or blanket bidding may be made for each exhibitor enterprise.

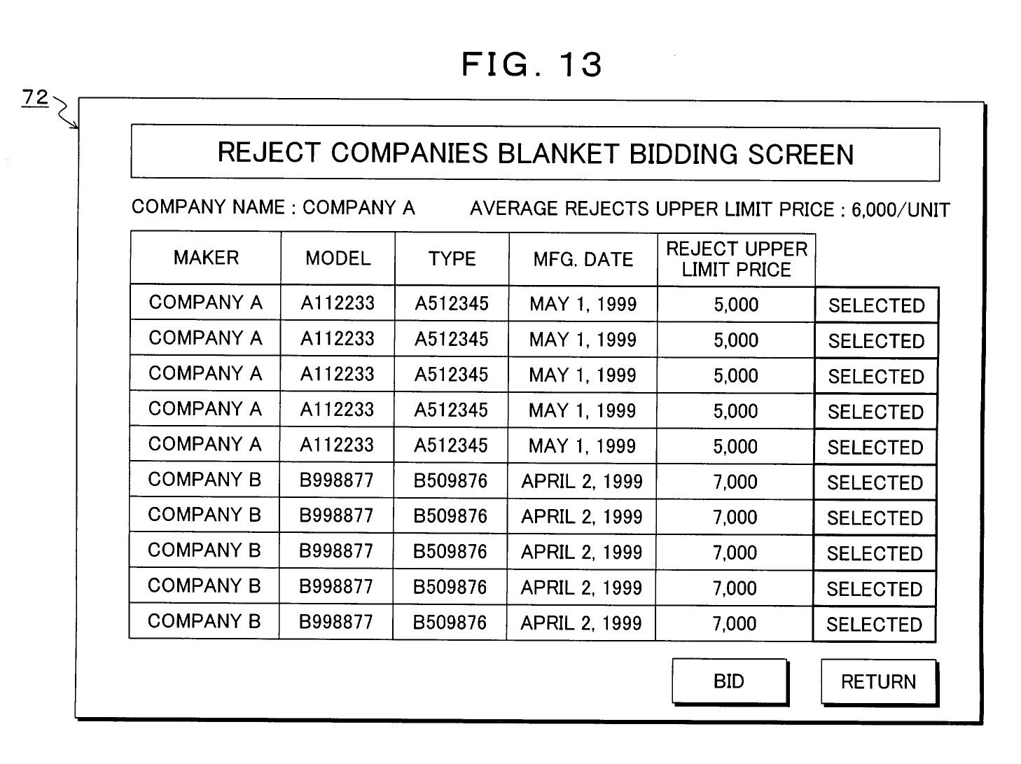

FIG. 13 is a blanket bidding screen 72 used for making a blanket bidding by a reject disposer in the reject market. In this blanket bidding screen 72, an idle product list 74 classified by sale wishing enterprise: for example, it is possible to make a blanket bidding for each enterprise by selecting five computers registered in the name of “Company A”. For the blanket bidding made by a reject disposer, if there is even only one idle product for which any other reject disposer has made a successful bid among the idle products covered by the blanket bidding, the blanket bidding becomes invalid, and bidding for each idle product is necessary in this case.

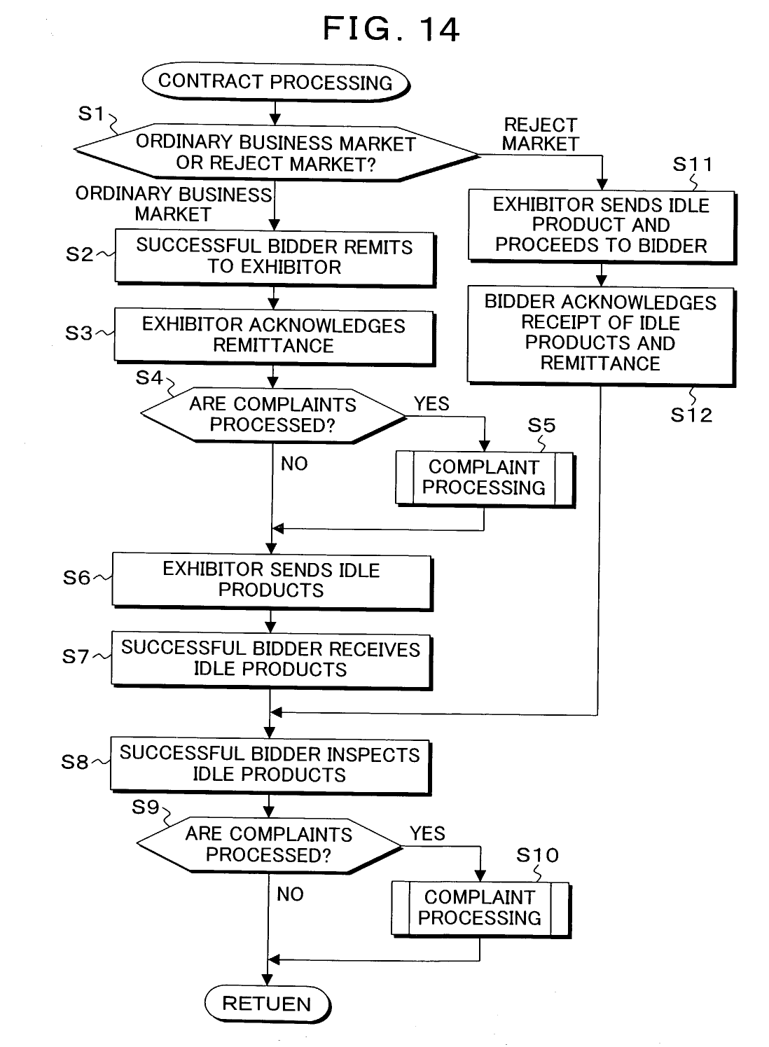

FIG. 14 is a flowchart illustrating details of contract processing in step S10 shown in FIG. 7. It is first checked whether the contract processing is for the ordinary trading market or for the reject market in step S1. If the contract is for the ordinary trading market, the process goes to step S2, and if for the reject market, to step S11. In contract processing for the ordinary trading market, the agreement upon transaction is reported to the sale wishing enterprise of the idle products covered by the successful bid and the client of the purchase wishing enterprise having made the successful bid from the server machine 10 on the basis of the agreement upon transaction. This report to the successful bidder contains basic data of the exhibiting enterprise including the name of enterprise, the representative, the contact, and the manner of remittance. In step S2, therefore, upon receipt of the report from the server machine, the successful bidder remits the necessary amount to the exhibitor. Then in step S3, the exhibitor acknowledges remittance, and in the next step S4, checks whether or not complaint processing is to be executed to the registration/inspection department on the server side. If complaint processing is executed, the complaint processing of step S5 is carried out. Then in step S6, the exhibitor sends the idle products after the completion of remittance, and in step S7, the successful bidder acknowledges the receipt of the idle products. In step S8, the successful bidder confirms performance of the idle products covered by the successful bid by use of the test program provided by the server. If presence of a problem in the received idle products is determined at this stage, it is determined whether or not the complaint processing it to be executed to the registration/inspection department on the server side in step S9. If it is to be executed, the complaint processing is carried out in step S10. When the contract processing is for the reject market in step S1, on the other hand, the exhibitor sends the idle products and the proceeds to the bidder in step S11. Upon the receipt thereof, the bidder acknowledges the receipt of the idle products and the proceeds. When the successful bidder in the reject market is an applicant for purchase, the bidder executes the test program provided by the server for the idle products to confirm the performance in step S8. If sa problem is encountered, complaint processing is executed in step S9, and the process proceeds to the complaint process of step S10. When the successful bidder in the reject market is a reject disposer, the idle products are transferred to reject proposal, thus skipping steps S8 to S10.

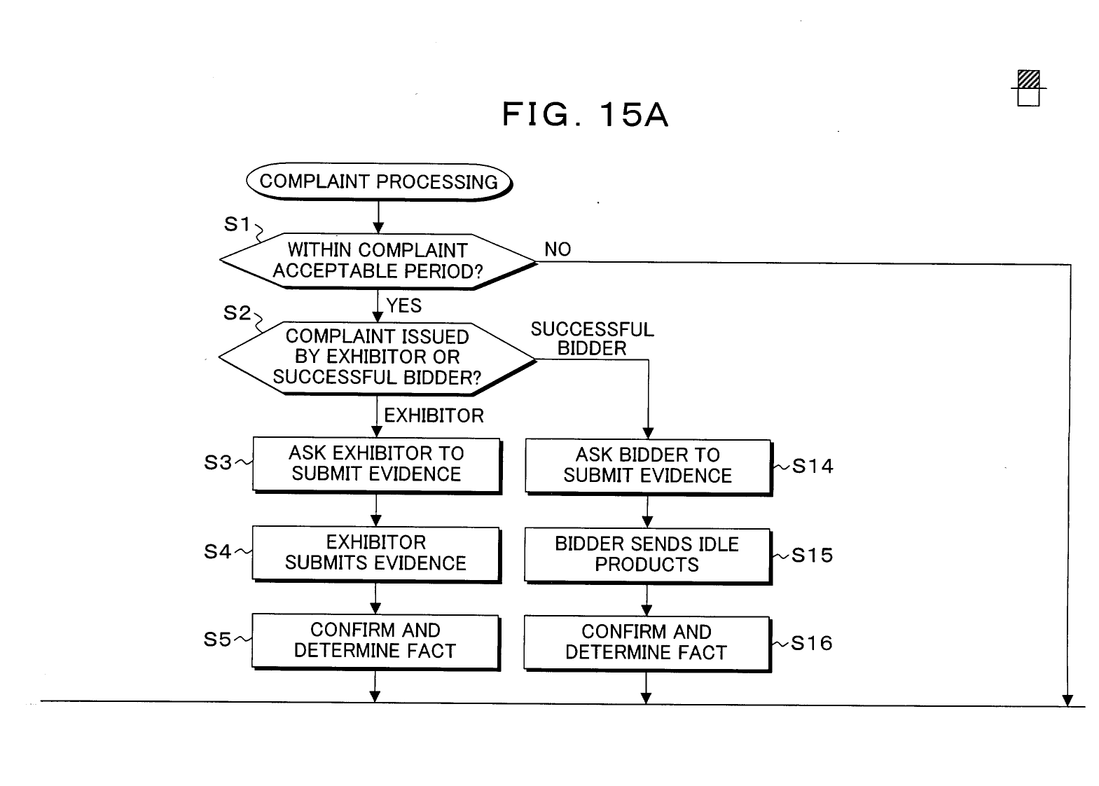

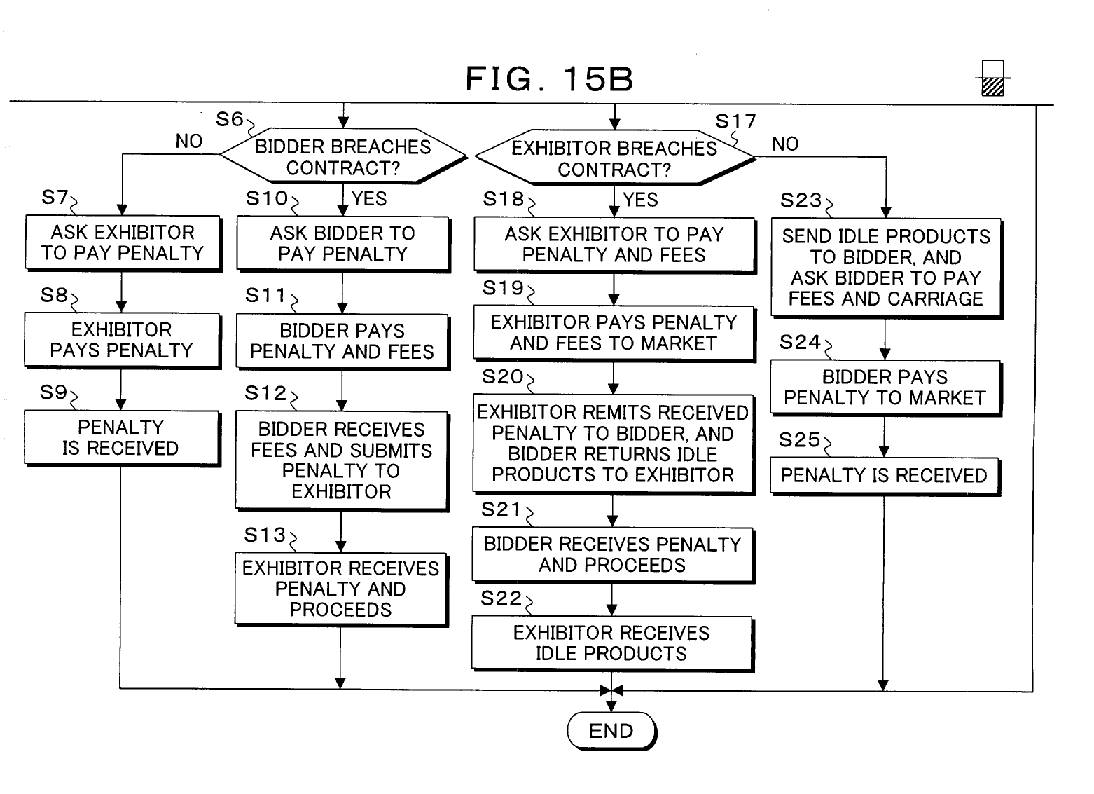

FIGS. 15A and 15B are flowcharts illustrating details of the complaint processing in step S5 shown in FIG. 14 and in step S10. In this complaint processing, when any problem is posed in the electronic commerce, for example, when a problem is found in the idle products, the remittance is not performed, or when there is a shortage of the amount of remittance, both the exhibitor and the successful bidder raise a claim to the registration/inspection department on the server side. In complaint processing, after determining whether or not it is within a prescribed period in step S1, the complaint is classified into the exhibitor or the bidder side in step S2. For a complaint from the exhibitor, processing of steps S3 to S13 is conducted. First in step S3, it is requested to the exhibitor having raised the claim to submit evidences. When remittance is not made, for example, a breakdown of the bank account is to be submitted. Then in step S5, investigation is carried out with reference to the submitted evidences to make fact finding and determination of the violator. In this case, it is possible to request the bidder as required to submit reference materials. It is checked whether or not the bidder is the violator in step S6. If the bidder has not problem, the exhibitor must have a problem. Payment of costs including expenses incurred by the bidder in taking necessary actions, investigation cost and fees incurred by the registration/inspection department is requested to the exhibitor as penalty in step S7. Upon receipt of this request, the exhibitor pays the penalty in step S8, and the receipt of the penalty paid is acknowledged in step S9. If the bidder is a violator in step S6, payment of penalty including a fine or investigation costs is requested to the bidder in step S10. Upon receipt of such a request, the bidder pays the penalty and the fees in step S11. The server receives the same in step S12, and sends the received penalty to the exhibitor in step S12. In step S13, the exhibitor receives the amount of penalty. If the bidder raises a complaint in step S2, the process of steps S14 to S25 are carried out. First in step S14, submission of evidences is requested to the bidder. For example, when the registered result of the test program does not agree with actual result of the test program, it is requested to send the test result and the idle products to the registration/inspection department. Upon receipt of the request, the bidder sends the idle products to the registration/inspection department in step S15, and in step S16, the registration/inspection department conducts investigation on the basis of the contents of complaint and the evidences. At this point in time, it is possible as required to submit reference materials to the exhibitor. Then in step S17, it is determined whether or not the exhibitor is a violator. If the exhibitor is a violator, the processes of steps S18 to S22 are carried out. More specifically, payment of penalty and fees is requested to the exhibitor in step S18. In step S19, the exhibitor pays penalty and fees to the market side. In step S20, the market receives the fees, sends the penalty to the bidder, and returns the idle products to the exhibitor. In step S21, furthermore, the bidder receives the penalty, and in step S22, the exhibitor receives the returned idle products. When the exhibitor has no problem, and the bidder violates the rules in step S17, the processes of steps S23 to S25 are executed. That is, in step S23, the idle products are returned to the bidder, and payment of the fees and carriage is requested. In step S24, the bidder pays the penalty to the market, and the market receives the same in step S25.

The present invention include appropriate variations within a range not impairing the objects and advantages thereof and is not limited by the numerical values shown in the aforementioned embodiments.

According to the present invention, as described above, it is possible to reuse information devices or the like held by an enterprise as idle products by presenting the same to a virtual market for commerce. For an enterprise desiring to purchase, it is possible to efficiently procure desired information equipment and devices from the electronic commerce market, thus permitting curtailment of investment in information equipment. Particularly, in the electronic commerce in the present invention, rejection of idle products is assumed. It is therefore possible to expect a very low bidding price upon successful bidding in the trading market, resulting in the possibility to remarkably reduce the amount of investment in information equipment when reusing idle products.

For an enterprise having idle products, even when no agreement is entered into upon market transaction, it is possible to automatically transfer to the reject market, and request receiving of the products to a reject disposer presenting a lowest disposal cost, thus permitting expectation of a remarkable curtailment of the rejecting cost.

In the reject market, it is possible for applicants for purchase of idle products for reuse other than reject disposers to make a bid specifying a negative price. Applicants for purchase for reuse in competition bidding with reject disposers therefore set a lower negative price for bidding. It is therefore possible to expect further curtailment of disposal cost as a result.

It is not necessary for a reject disposer to always check ordinary auctions, but information about information devices transferring to the reject market is available only by watching reject auctions, thus forming an easy-to-use market.

Electronic commerce in a virtual market of idle products promotes reuse of information devices and the like existing as idle products, causing an increase in demand and a decrease in the quantity of rejection. An advantage of solving the environmental problems is thus available.

In the aforementioned embodiments, information devices such as computers have been described as typical idle products. However, the present invention is not limited to them, but the same form of electronic commerce can basically be applied also to idle office fixtures such as desks, chairs and lockers.

What is claimed is:

1. A method for electronic commerce for building a virtual business market of goods on a computer, and conducting business by connecting a buyer's computer and a seller's computer via a network, comprising:
a registering step of causing a seller to register an idle product held by the seller on the market by specifying at least a desired sales price and a desired reject price in the case of rejection;
a purchase bidding step of soliciting the seller to make a bid by specifying a desired purchase price for an idle product rejected on said business market;
a market trading step of registering the idle product on the reject market when there is no bid satisfying said desired sales price upon the lapse of a prescribed business period;
a reject bidding step of causing reject disposers to make a bid by specifying a rejecting cost for an idle product registered on the reject market; and
a reject market trading step of checking presence or absence of bids upon the lapse of a prescribed business period, and executing a contracted disposal of the idle product when there is a bid satisfying said desired reject price.

2. A method for electronic commerce according to claim 1, wherein said registering step comprises, when said idle product is an information device:
a sub-step of providing the seller with a prescribed test program, and registering and disclosing the test result on the idle product obtained by the execution of said test program; and
a sub-step of providing the buyer with said test program, thereby enabling the buyer to obtain information about performance of said idle product of which the test result is registered through execution of said test program on an information device held by the buyer.

3. A method according to claim 1, wherein:
said registering step causes specification of a first minimum trading price and a last minimum trading price; and
said market trading step checks presence or absence of bids for each unit business period predetermined as a single run of auction period, d and when there is no bide satisfying the current minimum trading price or there is no bid, repeats an auction by reducing stepwise the current minimum trading price until said last minimum trading price is reached.

4. A method according to claim 3, wherein, in said market trading step, an amount obtained by dividing the difference between the first minimum trading price and the last minimum trading price by the number of runs of auction is used as an amount of reduction per auction.

5. A method according to claim 1, wherein said reject bidding step permits a purchase bidding specifying a negative purchase price for an idle product registered in the reject market.

6. A method according to claim 1, wherein said reject bidding step permits a blanket bidding in units of seller for an idle product registered in said reject market.

7. A method according to claim 1, wherein there is provided a market examination step of investigating a trouble occurring in the trading at the request of a party to a trade effectively made in said trading market or said reject market, and imposing a penalty on a violating party.

8. A program for electronic commerce, which causes a computer to execute:
a registering step of causing registration of an idle product held by a seller in a trading market by specifying at least a desired sales price, and a desired reject price if the idle product is to be rejected;
a purchase bidding step soliciting a buyer to make a bid by specifying a desired purchase price for an idle product registered in said trading market;
a market trading step of registering the idle product in the reject market when there is no bid satisfying said desired sales price at a point in time upon the lapse of a prescribed business period;
a reject bidding step of causing a reject disposer to make a bid by specifying reject cost and price for an idle product rejected in the reject market; and
a reject market trading step of checking the presence or absence of bids upon the lapse of a prescribed business period, and when there is a bid satisfying said desired reject price, executing a contract of rejecting the idle product.

9. A program according to claim 8, wherein, when said idle product is an information device, said registering step comprises:
a sub-step of providing the seller with a prescribed test program, and registering and disclosing a test result of the idle product obtained from execution of said test program; and
a sub-step of providing the buyer with said test program, and causing the buyer to execute said program on an information device held by the buyer, thereby permitting the buyer to obtain information about performance of said idle product of which the test result is registered.

10. A program according to claim 8, wherein:
said registering step is to cause specification of a first minimum trading price and a last minimum trading price; and
said market trading step is to check the presence or absence of a bid for each predetermined unit business period as a period for a single run of auction, and when there is no bid satisfying the current minimum price or there is no bid at all, to repeat auction by reducing stepwise the current minimum price until said last minimum trading price is reached.

11. A program according to claim 10, wherein, in said market trading step, an amount obtained by dividing the difference between the first minimum trading price and the last minimum trading price by the number of runs of auction is used as an amount of reduction per auction.

12. A program according to claim 8, wherein said reject bidding step permits a purchase bidding specifying a negative purchase price for san idle product registered in the reject market.

13. A program according to claim 8, wherein said reject bidding step permits a blanket bidding in units of seller for an idle product registered in said reject market.

14. A program according to claim 8, wherein there is provided a market examination step of investigating a trouble occurring in the trading at the request of a party to a trade effectively made in said trading market or said reject market, and imposing a penalty on a violating party.
